(19) United States
(12) Patent Application Publication
(10) Pub. No.: US 2017/0048850 A1
(43) Pub. Date: Feb. 16, 2017

(54) WIRELESS COMMUNICATION DATA TRANSMISSION METHOD AND SYSTEM

(71) Applicant: HUIZHOU TCL MOBILE COMMUNICATION CO., LTD, HuiZhou City, Guangdong (CN)

(72) Inventors: Shiqing ZHAO, HuiZhou City, Guangdong (CN); Shenggang HU, HuiZhou City, Guangdong (CN); Aiping George GUO, HuiZhou City, Guangdong (CN)

(73) Assignee: Huizhou TCL Mobile Communication Co., Ltd., Huizhou City, Guangdong (CN)

(21) Appl. No.: 15/114,077

(22) PCT Filed: Oct. 20, 2015
(86) PCT No.: PCT/CN2015/092307

§ 371 Date: Jul. 26, 2016

(30) Foreign Application Priority Data
Apr. 1, 2015 (CN) 201510150998.8

(51) Int. Cl. H04W 72/04; H04L 5/22; H04L 5/14

(52) U.S. Cl. CPC H04W 72/0446; H04L 5/14; H04L 5/22; H04W 92/10

(57) ABSTRACT

The present invention discloses a wireless communication data transmission method, receiving a data sent from a base station to a mobile terminal with a downlink frequency channel by using full-duplex technology; emitting a data emitted from the mobile terminal to the base station, and receiving the data sent from the base station to the mobile terminal by using time division multiplexing technology through an uplink frequency channel. The uplink frequency channel, which is originally only used for emitting a base station uplink data, is used for receiving a data originally only received by the downlink frequency channel.

### BACKGROUND OF THE INVENTION

1. Field of the Invention

The present invention relates to the wireless mobile communication field, and in particular to a wireless communication data transmission method and system.

2. Description of the Related Art

According to the 3GPP standard and the standard related to assigning wireless communication frequency channels, in the frequency division duplex communication mode, the frequency bandwidths of the uplink frequency channel and the downlink frequency channel of the wireless mobile station are the same. That is, the frequency bandwidth of the uplink frequency channel, emitting the data is equal to the frequency bandwidth of the downlink frequency channel receiving the data at the mobile station. However, the data rates and the data amounts of the uplink and the downlink of the mobile station arc usually different. In other words, the data rate and the data amount of the downlink are much greater than the data rate and the data amount of the uplink. In this way, the downlink frequency channel of the mobile station is usually congested, while the uplink frequency channel is usually idle, and this results in serious waste of the resource of the uplink frequency channel.

Therefore, the existing technology needs to be further improved.

### SUMMARY OF THE INVENTION

In view of the shortcoming of the existing technology aforementioned, the present invention aims to provide a data transmission method and system in the wireless communication, to solve the problem that the downlink frequency channel of the mobile station is usually congested, while the uplink frequency channel is usually idle, which results in a defect of lower efficiency during the wireless data transmission.

The scheme of the present invention solving the technical problem is as follows:

A wireless communication data transmission method, comprising:

receiving a data sent from a base station to a mobile terminal with a downlink frequency channel by using full-duplex technology;

acquiring a data amount to be emitted from the mobile terminal to the base station by using time division multiplexing technology;

allocating time duty cycles of emitting the data and receiving the data in the uplink frequency channel, according to a size of the data amount to be emitted;

emitting a data emitted from the mobile terminal to the base station, and receiving the data sent from the base station to the mobile terminal by using time. division multiplexing technology through the uplink frequency channel. The time duty cycle of emitting the data in the uplink frequency channel is proportional to the data amount to be emitted; the time duty cycle of receiving the data in the uplink frequency channel equals to the time duty cycle of transmitting the data minus the time duty cycle of emitting the data in the uplink frequency channel.

A wireless communication data transmission method, comprising:

receiving a data sent from a base station to a mobile terminal with a downlink frequency channel by using full-duplex technology;

emitting a data emitted from the mobile terminal to the base station, and receiving the data sent from the base station to the mobile terminal by using time division multiplexing technology through an uplink frequency channel.

The wireless communication data transmission method, before using the uplink frequency channel to emit the data emitted from the mobile terminal to the base station, and to receive the data sent from the base station send to the mobile terminal, further comprises: acquiring a data amount to be emitted from the mobile terminal to the base station;

allocating time duty cycles of emitting the data and receiving the data in t uplink frequency channel, according to a size of the data amount to be emitted.

In the wireless communication data transmission method, the time duty cycle of emitting the data in the uplink frequency channel is proportional to the data amount to be emitted.

The wireless communication data transmission method, the time duty cycle of receiving the data in the uplink frequency channel equals to the time duty cycle of transmitting the data minus the time duty cycle of emitting the data in the uplink frequency channel the uplink frequency channel.

A wireless communication data transmission system, comprising: a first control transmission module and a second control transmission module;

the first control transmission module used for receiving a data sent from a base station to a mobile terminal with a downlink frequency channel by using full-duplex technology;

the second control transmission module used for emitting a data emitted from the mobile terminal to the base station, and receiving the data sent from the base station to the mobile terminal by using time division multiplexing technology through the uplink frequency channel.

The wireless communication data transmission system, the control transmission module further comprises an information acquisition unit and a control transceiver unit;

the information acquisition unit used for acquiring a data amount to be emitted from the mobile terminal to the base station, before using the uplink frequency channel to emit the data emitted from the mobile terminal to the base station, and to receive the data sent from the base station send to the mobile terminal;

the control transceiver unit used for allocating time duty cycles of emitting the data and receiving the data in the uplink frequency channel, according to a size of the data amount to be emitted.

The wireless communication data transmission system, the time duty cycle of emitting the data in the uplink frequency channel is proportional to the data amount to be emitted.

The wireless communication data transmission system, the time duty cycle of receiving the data in the uplink frequency channel equals to the time duty cycle of transmitting the data minus the time duty cycle of emitting the data in the uplink frequency channel.

The present invention is advantageous in that it discloses a wireless communication data transmission method and system, receiving a data sent from a base station to a mobile terminal with a downlink frequency channel by using full-duplex technology; emitting a data emitted from the mobile terminal to the base station, and receiving the data sent from the base station to the mobile terminal by using time division multiplexing technology through an uplink frequency channel. The method and system use division multiplexing technology, the uplink frequency channel, which is originally used for emitting a base station uplink data, is used for receiving a data originally only received by the downlink frequency channel, the efficiency of receiving the data is increased, the utilization of the frequency channel transmitting the data is increased, and this better meets the needs of the customer.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1a illustrates a diagram of the frequency channel transmitting the data using the traditional full-duplex technology of the prior art;

FIG. 1b illustrates a diagram of the operation mode principle structure transmitting the data using the traditional full-duplex technology of the prior art;

FIG. 2 illustrates a flowchart of a specific embodiment of the wireless communication data transmission method of the present invention;

FIG. 3 illustrates a diagram of the operation mode principle structure of the wireless communication data transmission method of the present invention;

FIG. 4a illustrates a diagram of the operation mode principle of case 1 of the wireless communication data transmission method of the present invention;

FIG. 4b illustrates a diagram of the operation mode principle of case 2 of the wireless communication data transmission method of the present invention;

FIG. 4c illustrates a diagram of the operation mode principle of case 3 of the wireless communication data transmission method of the present invention; and

FIG. 5 illustrates a structural diagram of the principle of a wireless communication data transmission system of the present invention.

### DESCRIPTION OF THE EMBODIMENTS

As used in this specification the term “embodiment” means an instance, example, or illustration. In addition, for the articles in this specification and the appended claims, “a” or “an” in general can be interpreted as “one or more” unless specified otherwise or clear from context to determine the singular form.

In the drawings, the same reference numerals denote units with similar structures.

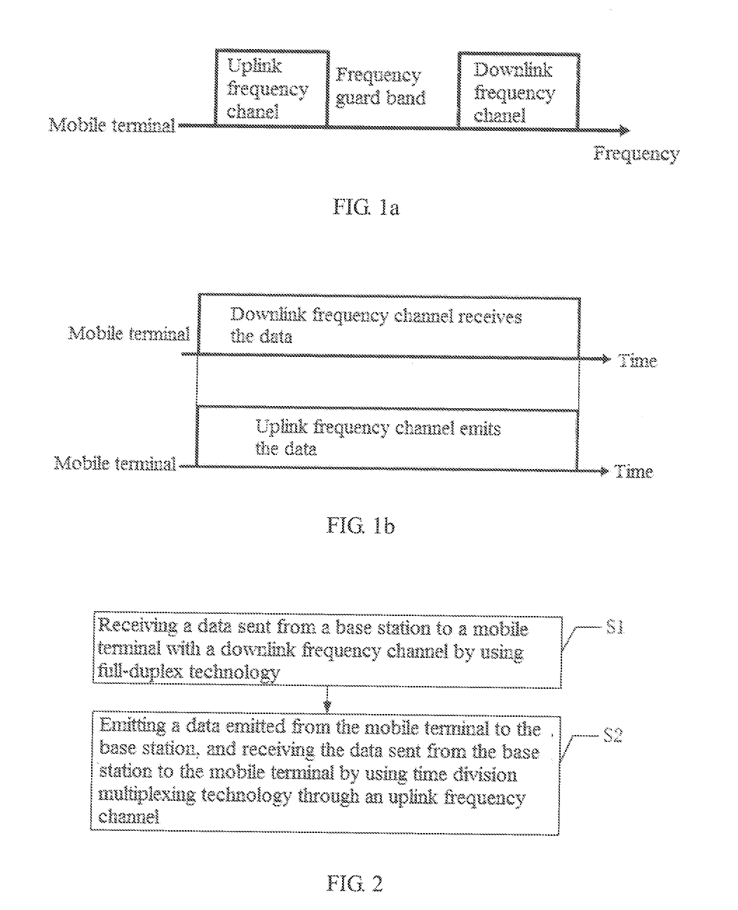

In the existing technology, the data transmitted between the mobile terminal and the base station based on full-duplex technology uses full duplex mode, that is, using the uplink frequency channel to transmit the data emitted from the mobile terminal to the base station, using the downlink frequency channel to transmit the data sent from the base station to the mobile terminal, the specific definition is as shown in FIG. 1a. According to the 3GPP standard, the frequency of the uplink frequency channel of the full duplex mobile terminal is lower than the frequency of the downlink frequency channel, that is, the uplink frequency channel is at the lower end of the frequency axis, and the downlink frequency channel is at the upper end of the frequency axis, there is a frequency guard band between the downlink frequency channel and the uplink frequency channel, to increase the isolation of emitting and receiving at the same time of the uplink and the downlink, decrease the mutual interference between emitting and receiving at the same time.

The uplink emitting the data and the downlink receiving the data of the full duplex mobile terminal can be performed at the same time, which is in full duplex mode, that is, the downlink frequency channel receives the data, while the uplink frequency channel emits the data at the same time, as shown in FIG. 1b, a diagram of the allocation of the frequency channel, wherein the full duplex mobile terminal can emit and receive at the same time. It can be seen from FIG. 1b, the uplink frequency channel and the downlink frequency channel can emit and receive the data at the same time, however, if the uplink frequency channel has no data to emit, then the frequency channel is idle, in this way, the uplink frequency channel is wasted, and the data amount received by the downlink frequency channel is usually larger, thus using full-duplex technology to transmit the data causes the low utilization of the frequency channel.

The present invention provides a wireless communication data transmission method, as shown in FIG. 2, the method includes:

S1, receiving a data sent from a base station to a mobile terminal with a downlink frequency channel by using full-duplex technology.

In the step, the traditional full-duplex technology is used, the downlink frequency channel is used to receive the data emitted from the base station, and transmit the data to the mobile terminal, and the downlink frequency channel is only used to receive the data emitted from the base station.

S2, emitting a data emitted from the mobile terminal to the base station, and receiving the data sent from the base station to the mobile terminal by using time division multiplexing technology through an uplink frequency channel.

But for the uplink frequency channel of the traditional full-duplex technology, then time division multiplexing is used to transmit the data, specifically, to allocate time duty cycles of emitting the data and receiving the data in the uplink frequency channel, according to a size of the data amount to be emitted. The data is emitted and received according to the allocated time duty cycle.

The uplink frequency channel of the traditional mobile station is used for the mobile station to emit the data to the base station, the aforementioned method is using the uplink frequency channel to receive the data emitted from the base station, when the uplink frequency channel of the mobile station is idle, and the uplink frequency channel of the mobile station is changed from receiving to emitting, when the mobile station emits the data, that is, the uplink frequency channel of the mobile station using time division multiplexing mobile station realizes that the mobile station uses the uplink frequency channel to emit and receive the data in divided time.

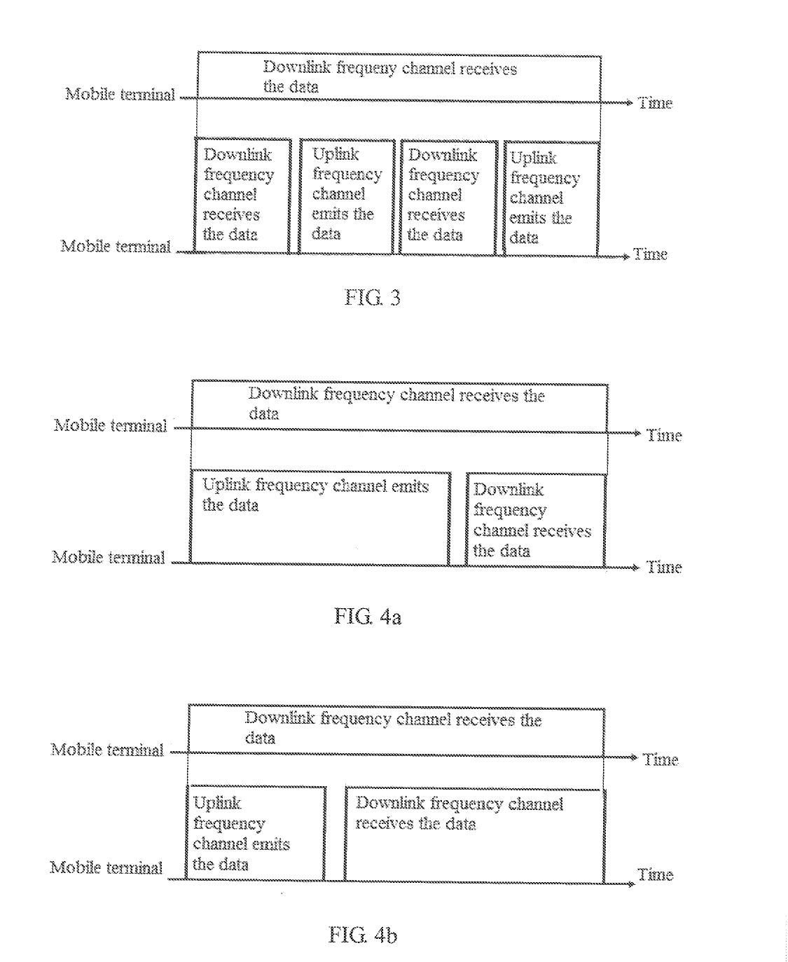

FIG. 3 illustrates a timing diagram of the uplink frequency channel of the specific embodiment of the method, the mobile station using the uplink frequency channel to emit and receive the data in divided time is realized through time division multiplexing. It can be seen from FIG. 3, when the downlink frequency channel of the mobile station receives the data, the uplink frequency channel of the mobile station can receive and emit the data in divided time, the uplink frequency channel is fully used.

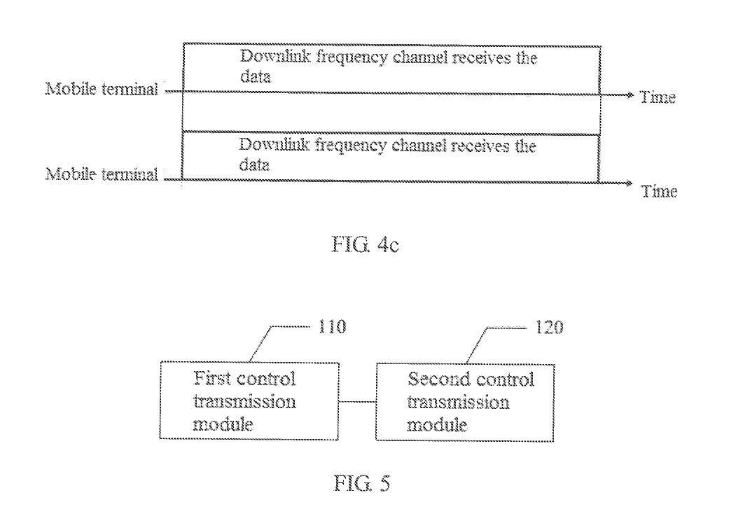

Specifically, as shown in FIG. 4a-FIG. 4c, the uplink frequency channel of the mobile station uses time division multiplexing to receive the data sent from the base station, and to emit the data transmitted from the mobile terminal to the base station, the time duty cycle of receiving and emitting the data can be determined according to the emitted and received data amount. In the specific process of the embodiment, a data amount to be emitted from the mobile terminal to the base station is acquired first; then the time duty cycles of emitting the data and receiving the data in the uplink frequency channel are allocated, according to a size of the data amount to be emitted, wherein the time duty cycle of emitting the data in the uplink frequency channel is proportional to the data amount to be emitted, the time duty cycle of receiving the data in the uplink frequency channel equals to the time duty cycle of transmitting the data minus the time duty cycle of emitting the data in the uplink frequency channel.

In the specific transmission process, case 1, as depicted in FIG, 4a, when the emitted data amount is large, the duration of emitting is increased, and the duration of the receiving is decreased. Case 2, as shown in FIG. 4b, when the emitted data amount is small, the duration of the emitting is short, and the duration of the receiving is correspondingly extended. Case 3, as shown in FIG. 4c, if there is no data emitted during a period of time, then the uplink frequency channel can be used for receiving the data sent from the base station to the mobile terminal during the period of time.

Based on the aforementioned method, the present invention further provides a wireless communication data transmission system, as shown in FIG. 5, the system includes: the first control transmission module 110 and the second control transmission module 120.

The first control transmission module 110 is used for receiving a data sent from a base station to a mobile terminal with a downlink frequency channel by using full-duplex technology.

The second control transmission module 120 is used for using time division multiplexing technology, emitting a data emitted from the mobile terminal to the base station, and receiving the data sent from the base station to the mobile terminal by using time division multiplexing technology through the uplink frequency channel.

The wireless communication data transmission system, Wherein the control transmission module further includes an information acquisition unit and a control transceiver unit.

The information acquisition unit is used for acquiring a data amount to be emitted from the mobile terminal to the base station.

The control transceiver unit is used for allocating time duty cycles of emitting the data and receiving the data in the uplink frequency channel, according to a size of the data amount to be emitted.

The wireless communication data transmission system, wherein the time duty cycle of emitting the data in the uplink frequency channel is proportional to the data amount to be emitted.

The wireless communication data transmission system, wherein the time duty cycle of receiving the data in the uplink frequency channel equals to the time duty cycle of transmitting the data minus the time duty cycle of emitting the data in the uplink frequency channel.

The present invention provides a wireless communication data transmission method and system, receiving a data sent from a base station to a mobile terminal with a downlink frequency channel by using full-duplex technology; emitting a data emitted from the mobile terminal to the base station, and receiving the data sent from the base station to the mobile terminal by using time division multiplexing technology through an uplink frequency channel. The method and system use division multiplexing technology, the uplink frequency channel, which is originally only used for emitting a base station uplink data, is used for receiving a data originally only received by the downlink frequency channel, the efficiency of receiving the data is increased, the utilization of the frequency channel transmitting the data is increased, this better meets the needs of the customer.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

1. A wireless communication data transmission method, comprising:
receiving a data sent from a base station to a mobile terminal with a downlink frequency channel by using full-duplex technology;
acquiring a data amount to be emitted from the mobile terminal to the base station by using time division multiplexing technology;
allocating time duty cycles of emitting the data and receiving the data in the uplink frequency channel according to the data amount to be emitted;
emitting a data emitted from the mobile terminal to the base station and receiving the data sent from the base station to the mobile terminal by using time division multiplexing technology through the uplink frequency channel;
wherein the time duty cycle of emitting the data in the uplink frequency channel is proportional to the data amount to be emitted; the time duty cycle of receiving the data in the uplink frequency channel equals to the time duty cycle of transmitting the data minus the time duty cycle of emitting the data in the uplink frequency channel.

2. A wireless communication data transmission method, comprising:
receiving a data sent from a base station to a mobile terminal with a downlink frequency channel by using full-duplex technology;
acquiring a data amount to be emitted from the mobile terminal to the base station;
allocating time duty cycles of emitting the data and receiving the data in the uplink frequency channel, according to a size of the data amount to be emitted; and
emitting a data emitted from the mobile terminal to the base station, and receiving the data sent from the base station to the mobile terminal by using time division multiplexing technology through an uplink frequency channel.

3. (canceled)

4. The wireless communication data transmission method of claim 2, wherein the time duty cycle of emitting the data in the uplink frequency channel is proportional to the data amount to be emitted.

5. The wireless communication data transmission method. of claim 2, wherein the time duty cycle of receiving the data in the uplink frequency channel equals to the time duty cycle of transmitting the data minus the time duty cycle of emitting the data in the uplink frequency channel the uplink frequency

6. A wireless communication data transmission system, comprising:
a processor;
a memory connected with processor, the memory comprising a plurality of program instructions executable by the processor, the plurality of program instructions comprising:
a first control transmission module and a second control transmission module;
the first control transmission module configured to cause the processor to receive a data sent from a base station to a mobile terminal with a downlink frequency channel by using full-duplex technology;
the second control transmission module configured to cause the processor to emit a data emitted from the mobile terminal to the base station, and to receive the data sent from the base station to the mobile terminal by using time division multiplexing technology through the uplink frequency channel.

7. The wireless communication data transmission system of claim 6, wherein the control transmission module further comprises an information acquisition unit and a control transceiver unit;
the information acquisition unit configured to cause the processor to acquire a data amount to be emitted from the mobile terminal to the base station, before using the uplink frequency channel to emit the data emitted from the mobile terminal to the base station, and to receive the data sent front the base station send to the mobile terminal;
the control transceiver unit configured to cause the processor to allocate time duty cycles of emitting the data and to receive the data in the uplink frequency channel, according to a size of the data amount to be emitted.

8. The wireless communication data transmission system of claim 7, wherein the time duty cycle of emitting the data in the uplink frequency channel is proportional to the data amount to be emitted.

9. The wireless communication data transmission system of claim 7, wherein the time duty cycle of receiving the data in the uplink frequency channel equals to the time duty cycle of transmitting the data minus the time duty cycle of emitting the data in the uplink frequency channel.
